(19) United States
(12) Patent Application Publication
(10) Pub. No.: US 2011/0231930 A1
(43) Pub. Date: Sep. 22, 2011

(54) INCORPORATING VISUAL ASPECTS TO IDENTIFY PERMISSIONS AND SECURITY LEVELS IN AGGREGATED CONTENT

(75) Inventor: Arthur G. Howarth, Orleans (CA)

(73) Assignee: CISCO TECHNOLOGY, INC., San Jose, CA (US)

(21) Appl. No.: 12/725,574

(22) Filed: Mar. 17, 2010

(51) Int. Cl. G06F 17/30; G06F 12/14

(52) U.S. Cl. 726/21; 707/783; 726/30

(57) ABSTRACT

In one embodiment, a method includes identifying content associated with a composition and at least one authorization associated with a user. The content is a subject of a request for access associated with the user, and is an aggregate of a plurality of sections. The plurality of sections includes a first section with a first authorization level and a second section with a second authorization level that is higher than the first authorization level. The method also includes determining if at least one authorization indicates that the user may access the first section and determining if at least one authorization indicates that the user may access the second section. The first section is portrayed to the user if it is determined that the user may access the first section, and the second section is portrayed to the user if it is determined that the user may access the second section.

### BACKGROUND

The disclosure relates generally to networking, and more particularly to collaborative environments.

Within collaborative environments, or environments in which that is information collaboration and reporting, different parties often have different permissions and/or security levels. For example, one party to a collaboration may have permissions and/or a security level that enables that party to view substantially all the content associated with a document, while another party may have permissions and/or a security level that enables that party to view a lesser amount of content. Thus, it often becomes difficult to share or to otherwise “portray” documents in a collaborative environment, as it is desirable to prevent parties without proper authorization and/or security levels from viewing or otherwise accessing content of the documents, e.g., sensitive content, to which they are not entitled.

Often, a party sharing information in a collaborative environment with another party must parse the information to identify the pieces of information that may be shared. As the amount of information shared in collaborative environments increases, and the number of parties participating in collaborative environments increases, the ability to effectively manage information such that information is substantially only portrayed, e.g., displayed or availed to, those parties with appropriate permissions and/or security levels is becoming increasingly difficult.

### BRIEF DESCRIPTION OF THE DRAWINGS

The disclosure will be readily understood by the following detailed description in conjunction with the accompanying drawings in which:

FIG. 1A is a diagrammatic representation of a document, a blog, or a wiki that includes sections of content that are associated with different security levels or permissions in accordance with an embodiment.

FIG. 1B is a diagrammatic representation of a document, a blog, or a wiki that includes sections of content that are associated with different security levels or permissions, as presented to a user with a lowest security permission in accordance with an embodiment.

FIG. 1C is a diagrammatic representation of a document, a blog, or a wiki that includes sections of content that are associated with different security levels or permissions, as presented to a user with an intermediate security permission in accordance with an embodiment.

FIG. 1D is a diagrammatic representation of a document, a blog, or a wiki that includes sections of content that are associated with different security levels or permissions, as presented to a user with a highest security permission in accordance with an embodiment.

FIG. 2 is a process flow diagram which illustrates a method of processing a user request to view content in accordance with an embodiment.

FIG. 3 is a block diagram representation of an overall system that supports displaying content to a user based upon permissions and a security level associated with the user in accordance with an embodiment.

FIG. 4 is a diagrammatic representation of a process of presenting content to a user in accordance with an embodiment.

### DESCRIPTION OF EXAMPLE EMBODIMENTS

### General Overview

According to one aspect, a method includes identifying content associated with an instance of content or a composition, and identifying at least one authorization associated with a user. The content is a subject of a request for access associated with the user, and is an aggregate of a plurality of sections. The plurality of sections includes at least a first section with a first authorization level and a second section with a second authorization level that is higher than the first authorization level. The method also includes determining if at least one authorization indicates that the user may access at least the first section and determining if at least one authorization indicates that the user may access at least the second section. The first section is portrayed to the user if it is determined that the user may access at least the first section, and the second section is portrayed to the user if it is determined that the user may access at least the second section.

### DESCRIPTION

The use of collaborative environments or, more generally, environments, in which resources are shared between multiple parties, is rapidly increasing. Shared resources may generally include, but are not limited to including, instances of content or compositions such as documents, blogs, and wikis. Parties which generally have access to shared resources may have different access permissions and/or security levels. A shared resource such as a composition may include blocks of content that a party with a relatively low security level may access, as well as blocks of content that the party may not access. Rather than preventing the party from viewing any of the composition because the composition includes blocks of content that the party is not authorized to access, the party may be allowed to view substantially only those blocks of the document that the party is authorized to access. As such, the party may view information in the document that the party is entitled to view, and may essentially be prevented from viewing information in the same document that the party is not entitled to view.

By substantially separating content into relatively discrete units that are at least partly identified by permissions and/or security levels, a system may be arranged to cause substantially only the content that a user has authorization to view to be accessed by, e.g., viewed by, the user. In one embodiment, a composition may be an aggregation of discrete blocks or units of content. Thus, a user may only access the portions of a composition, e.g., an aggregate of relatively discrete units of content, that his permissions and/or security level allows him to access. The aggregated content associated with a composition may essentially be disaggregated such that different users may access different sections of the content, as substantially dictated by the privileges or authorization granted to the different users. A user with relatively high permissions and/or a relatively high security level may be able to access an entire composition, or substantially all content associated with the composition. On the other hand, a user with relatively low permissions and/or a relatively low security level may be substantially restricted from viewing much of the composition or content associated with the composition.

In one embodiment, an administrator, e.g., an owner of an instance of content or a composition, may be able to readily identify the security levels associated with different units or sections of the composition. That is, the security levels of discrete units or sections of content that are included in a composition may be readily identifiable to an administrator. For example, the discrete units may be tagged or otherwise marked to indicate associated security levels. Tagging may include, but is not limited to including, applying colors or other visual indicators to the discrete units based on the security level of the discrete units. Thus, an administrator may be able to visually assess which portions of a composition may be viewed, or otherwise accessed, by parties with particular security levels.

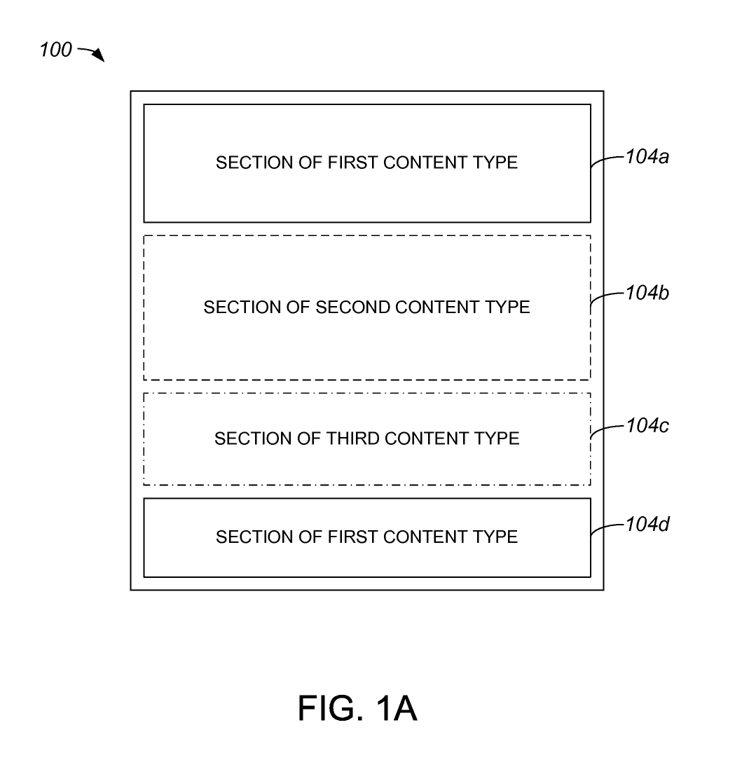

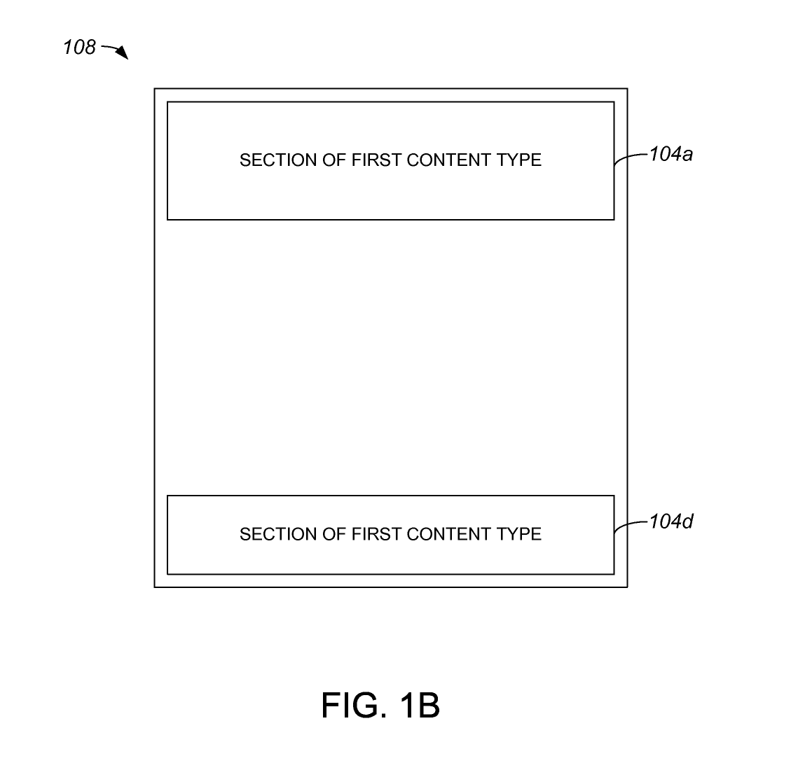

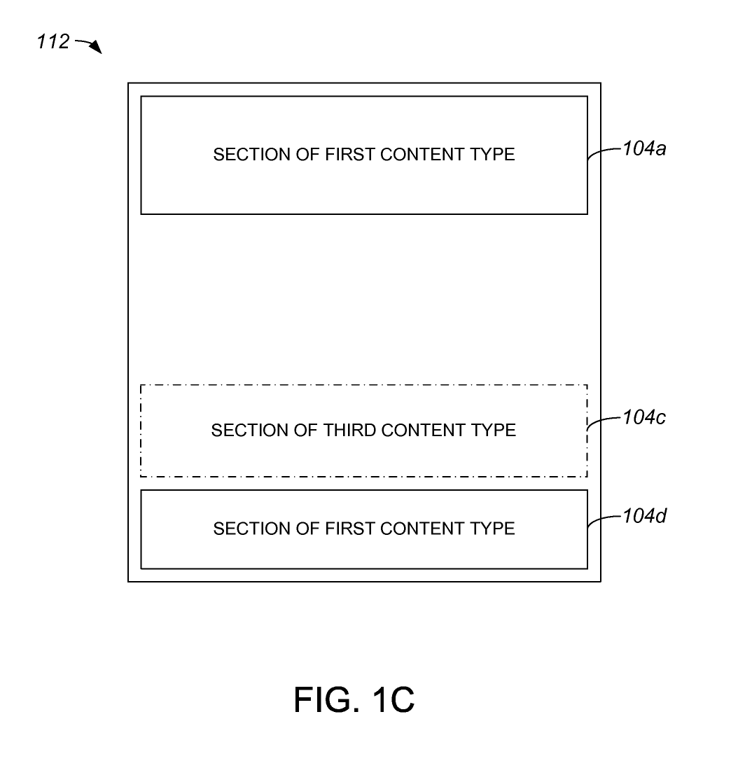

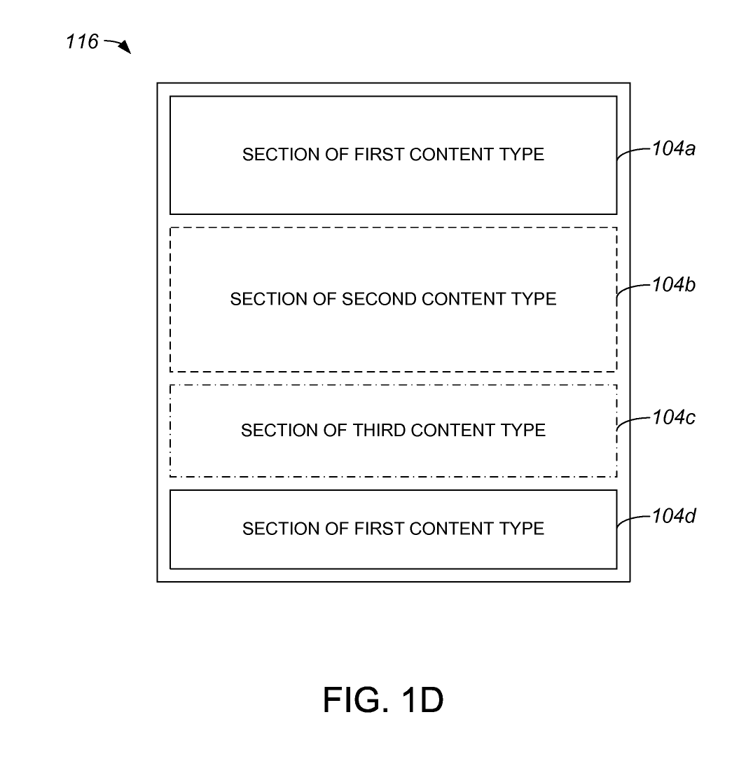

With reference to FIGS. 1A-D, one example of an instance of content composition which is effectively parsed or otherwise divided into discrete units based on associated permissions and/or security levels will be described. Referring initially to FIG. 1A, a diagrammatic representation of a composition, e.g., a blog or a wiki, that includes sections of content associated with different permissions and/or security levels will be described in accordance with an embodiment. A composition 100 includes two sections of a first content type 104a, 104d, as well as a section of a second content type 104b and a section of a third content type 104c. Composition 100 is effectively an aggregate of sections 104a-d.

It should be appreciated that composition 100 may generally include any number of sections and any number of content types. Content may generally include static content and/or dynamic content. The number of sections and the number of content types illustrated in FIG. 1A is shown purely for ease of discussion. The representation of composition 100, as shown, may be a representation which is available to an owner of composition 100 or, more generally, and administrator or “super user” of composition 100.

In one embodiment, sections of the first content type 104a, 104d may be viewable, or otherwise accessed, by users having any permissions and/or security level. That is, even users with the most restrictive permissions and/or lowest security levels are substantially authorized to view or otherwise access sections 104a, 104d. Section of the second content type 104b may be viewable, or otherwise accessed, substantially only by users having the least restrictive permissions and/or highest security level. Section of third content type 104c may be viewable, or otherwise accessed, by users with any permissions which are less restrictive than the most restrictive permissions and/or any security level that is higher than the lowest security level. In general, users may include human users as well as machines, e.g., computing devices, and/or applications that request access.

Sections 104a-d may include visual aspects that are arranged to indicate the permissions and/or security levels associated with, e.g., needed by an audience or a user in order to view, sections 104a-d. For example, sections 104a, 104d may be highlighted with a first color intended to indicate that sections 104a, 104b have the most restrictive permissions and/or lowest security levels. Similarly, section 104b may be highlighted with a second color intended to indicate that section 104b is accessible substantially only by users with the least restrictive permissions and/or the highest security levels. Finally, section 104c may be highlighted with a third color intended to indicate that section 104d is accessible by users with “intermediate” restrictive permissions and/or “intermediate” security levels.

FIG. 1B is a diagrammatic representation of composition 100 of FIG. 1A as presented to a user with the most restrictive permissions and lowest security level in accordance with an embodiment. A representation 108 includes sections of the first content type 104a, 104b, as sections of the first content type 104a, 104b are associated with the most restrictive permissions and/or the lowest security level. Thus, when composition 100 of FIG. 1A is essentially presented to a user with the most restrictive permissions and/or the lowest security level, representation 108 is displayed. Therefore, the user with the most restrictive permissions and/or the lowest security level is presented with representation 108 when he or she requests access to composition 100 of FIG. 1A, and content that such a user is not authorized to view is not presented to the user.

It should be appreciated that representation 108 may optionally include an indication (not shown) configured to indicate that some content of composition 100 of FIG. 1A is omitted from representation 108. Such an indication (not shown) may be, but is not limited to being, a visual indication such as a darkened area which replaces content that is not included in representation 108 or a visual indication such as text which effectively states that some content has been omitted.

When a user with less restrictive permissions than the most restrictive permissions and/or a higher security level than the lowest security level requests access to composition 100 of FIG. 1A, that user is presented with a representation 112 of composition 100, as shown in FIG. 1C. Representation 112 includes sections of the first content type 104a, 104b and section of the third content type 104c. Section of the third content type 104c is viewable to any user with less restrictive permissions than the most restrictive permissions and/or a higher security level than the lowest security level. In the embodiment as shown, a user with mid-level permissions and a mid-level security level is presented with section of the third content type 104c because section of the third content type 104c is generally viewable by any user with less restrictive permissions than the most restrictive permissions and/or a higher security level than the lowest security level.

As previously mentioned, section of the second content type 104b of FIG. 1A is viewable by or otherwise accessible to substantially only users with the least restrictive permissions and/or the highest security level. FIG. 1D is a diagrammatic representation of a rendering 116 of composition 100 of FIG. 1A as presented to a user with the least restrictive permissions and/or the highest security level in accordance with an embodiment. A user with the least restrictive permissions and/or the highest security level may have, in one embodiment, the authorization to view or otherwise access substantially all of composition 100 of FIG. 1A. Rendering 116 includes substantially all viewable content of composition 100 of FIG. 1A. As shown, rendering 116 includes sections of the first content type 104a, 104b, in addition to section of third content type 104c and section of the second content type 104b.

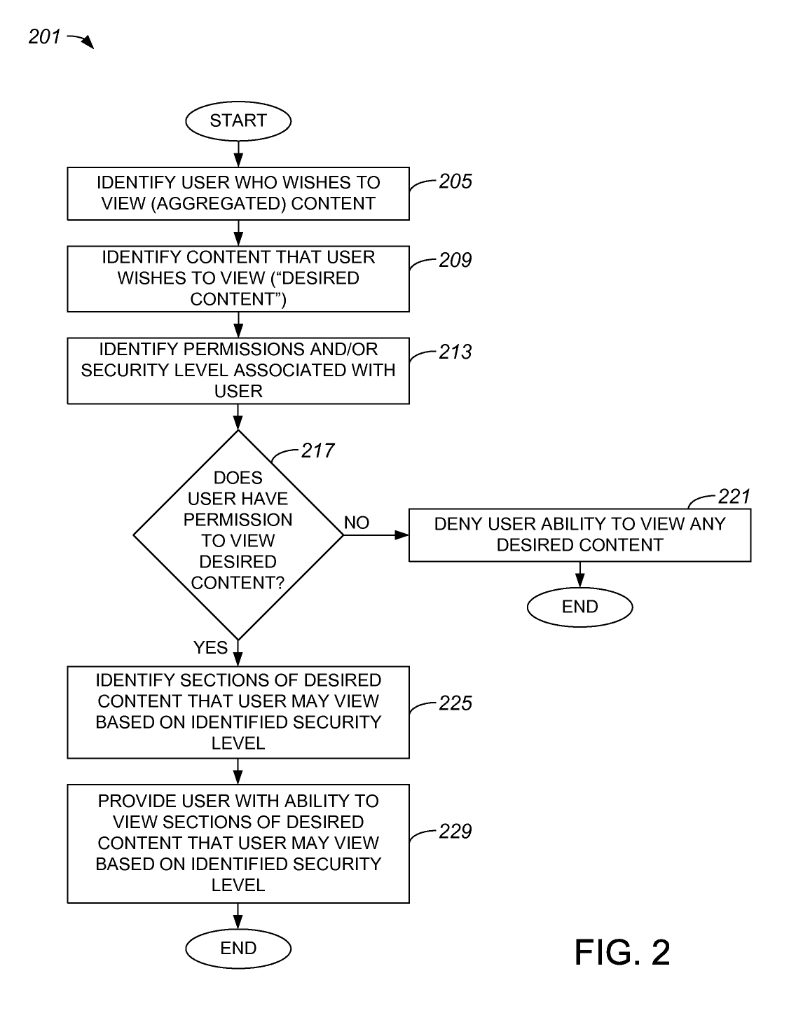

In general, when a user requests access to content, the user requests that content be portrayed, e.g., displayed or otherwise rendered, such that the user may at least view the content. FIG. 2 is a process flow diagram which illustrates a method of processing a user request to view content in accordance with an embodiment. It should be appreciated that although a user request to view content is described, a request for a user to view content may instead come from another party, as for example an owner of a composition that includes the content. A process 201 of processing a user request to view content begins at step 305 in which the user who wishes to view content, e.g., aggregated content, is identified. The aggregated content may, for example, be sections of content or data that are substantially aggregated in a composition such as a blog or a wiki. Identifying the user may include, but is not limited to including, parsing the user request or, more generally, information received from the user to locate pieces of information that identify the user.

After the user is identified, the content that the user wishes to view is identified in step 209. Identifying the content that the user wishes to view, or identifying desired content, may include parsing the user request. The content may be the subject of the user request. Once the desired content is identified, permissions and/or the security level associated with the user or, more generally, authorizations associated with the user, may be identified in step 213. The permissions and/or the security level associated with the user may be identified by searching a data arrangement, e.g., a database or a data file, that maintains information relating to permissions and/or security levels associated with various users. In one embodiment, a security level associated with the user may generally indicate a highest level of information that the user is effectively authorized to access, while permissions associated with the user may generally indicate topics the user is authorized to access regardless of a security level associated with the user.

A determination is made in step 217 as to whether the user has permission to view the desired content. That is, it is determined whether the user is authorized to access, or has privileges sufficient to allow access to, the content identified in step 209. Such a determination may include determining whether the permissions associated with the user allow for access to the desired content, and/or whether the security level associated with the user is high enough to enable the user to access the desired content. If the determination in step 217 is that the user does not have permission to view the desired content, then the user is denied the ability to view or otherwise access the desired content in step 221, and the process of processing a user request is completed.

Alternatively, if it is determined in step 217 that the user has permission to view the desired content, the indication is that the permissions and/or the security level associated with the user are appropriate to allow the user to view at least some of the desired content. As such, process flow moves to step 225 in which sections of the desired content that the user may view are identified based on the security level associated with the user, i.e., the security level identified in step 213. Identifying sections of the desired content that the user may view may involve, in one embodiment, comparing tags associated with the sections of desired content against the permissions and/or security level associated with the user.

Once the desired sections of content that the user may view are identified, the user is provided in step 229 with the ability to view or otherwise access the identified sections of content. By way of example, the identified sections of content may be rendered for display to the user. After the identified sections of content are effectively provided to the user, the process of processing a user request is completed.

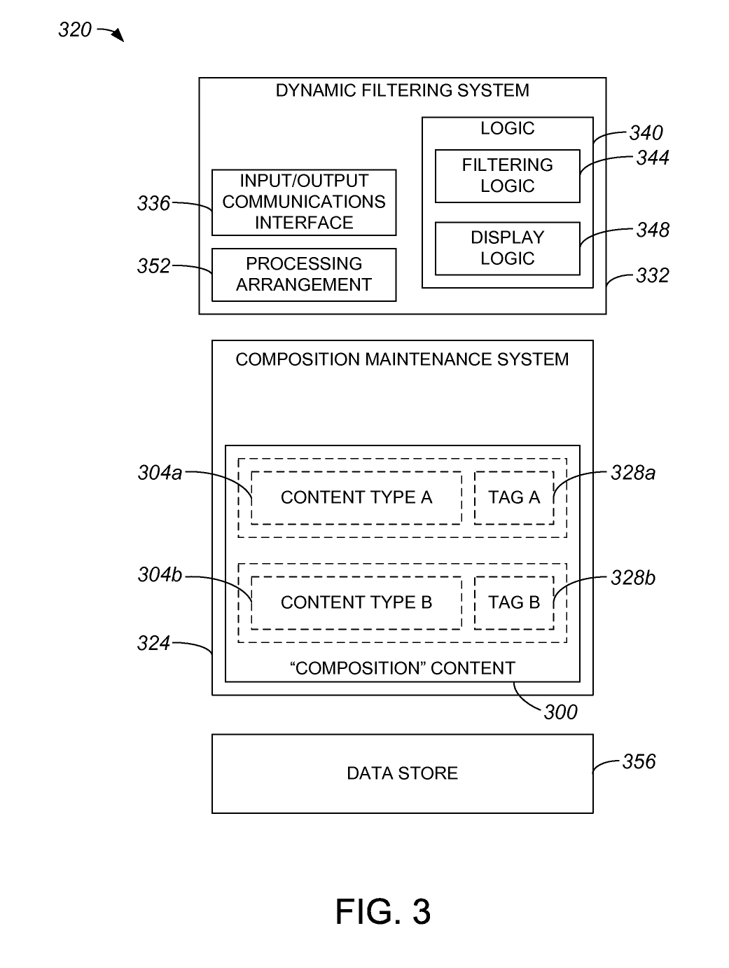

The functionality to access a composition and to support identifying suitable content of the composition that may be rendered, e.g., displayed, to a user based on permissions and/or a security level associated with the user will be described with reference to FIG. 3. FIG. 3 is a block diagram representation of an overall system that supports displaying content to a user based upon permissions and a security level associated with the user in accordance with an embodiment. An overall system 320 is configured to generate appropriate information for use by a user. In other words, overall system 320 is arranged to identify sections of composition content 300 that a user is authorized to view, and to present those sections to the user.

Overall system 320 may be a distributed system, with various components of overall system 320 being at different locations within a network. It should be appreciated, however, that overall system 320 is not limited to being a distributed system. By way of example, overall system 320 may be embodied on a single computing system.

Overall system 320 includes a composition maintenance system or arrangement 324, a dynamic filtering system or arrangement 332, and a data store 356. Composition maintenance system 324 generally maintains composition content 300. In one embodiment, composition maintenance system 324 may be associated with a blog application or a wiki application. Dynamic filtering system 332 is generally arranged to process a request to provide a user with the ability to view or otherwise access composition content 300 or, more specifically, sections of composition content 300 that the user is authorized to view. Data store 356 may store, but is not limited to storing, information relating to composition content 300 and information relating to permissions and/or security levels.

Composition maintenance system 324 stores content 304a, 304b and tags 328a, 328b, respectively, that are associated with content 304a, 304b. In one embodiment, tags 328a, 328b may be applied by an owner, i.e., an owner of the content, at the time the content is created.

Tags 328a, 328b may generally indicate the types of permissions and/or security levels that are needed in order to gain access to content 304a, 304b, respectively. For example, tag 328a may provide an indication about the permissions and/or security levels needed by a user in order for content 304a to be portrayed to the user. Tags 328a, 328b may also reflect topics associated with content 304a, 304b, respectively. A comparison of tags 328a, 328b against the permissions and/or security levels or, more generally, the authorization associated with a user may allow a determination of whether the user is authorized to access content 304a, 304b associated with tags 328a, 328b, respectively. It should be appreciated that when tags 328a, 328b include information relating to the topics contained in content 304a, 304b, respectively, a comparison of tags 328a, 328b against the permissions of a user may involve a determination of whether the user may access the topics contained in content 304a, 304b.

Tags 328a, 328b may also be arranged to provide a physical indication, e.g., a visual indication, of the permissions and/or security levels needed by a user in order for content 304a, 304b, respectively, to be portrayed to the user. In one embodiment, tag 328a may effectively visually highlight content 304a in a color that indicates how sensitive content 304a is and, therefore, provide a visual indication of the permissions and/or security levels that a user should have if content 304a is to be portrayed to the user.

Dynamic filtering system 332 includes logic 340 that allows dynamic filtering to be implemented. Logic 340 may generally include, but is not limited to including, hardware and/or software logic that is embodied on a tangible media. Dynamic filtering system 332 also includes a processing arrangement 352 that is capable of executing logic 340, and an input/output communications interface 336.

Logic 340 includes filtering logic 344 and display logic 348. Filtering logic 344 is arranged to dynamically filter composition content 300 based on information relating to an audience for composition content 300. For example, if the audience for composition content 300 has relatively low permissions and/or a relatively low security level, filtering logic 344 may filter composition content 300 such that only content 304a, 304b which is consistent with the relatively low permissions and/or relatively low security level. Display logic 348 is configured to display or otherwise render composition content 300 or, more specifically, composition content 300 filtered by filtering logic 344 to an audience. Display logic 348 may, in one embodiment, highlight composition content 300 such that permissions and/or security levels associated with composition content 300, as displayed to an audience, may be readily identified. In other words, display logic 348 may provide visual aspects that enable permissions and/or security levels associated with composition content 300 to be readily assessed. For example, display logic 348 may highlight different sections of content within composition content 300 with different colors such that permissions and/or security levels associated with those sections may be visually ascertained. It should be appreciated that display logic 348 may generally be logic that is configured to render content, and that rendering content is not limited to displaying content. By way of example, rendering content may include presenting content in an audible manner.

Processing arrangement 352 may cooperate with logic 340 to filter composition content 300, and to determine which sections of composition content 300 are appropriate to portray to a given audience. Input/output communications interface 336 is configured to allow dynamic filtering system 332 to communicate with composition maintenance system 324 and with data store 356, e.g., across a network. Input/output communications interface 336 is further configured to obtain information relating to an audience or a user, e.g., a user request for access to composition content 300, that may be used to identify the audience or user, as well as to identify associated permissions and/or an associated security level. Information relating to an audience or a user may be obtained from, but is not limited to being obtained from, a computing device operated by the audience as login information or an RFID tag associated with the audience.

Data store 356 may store information or content that is aggregated in composition content 300. In other words, in lieu of storing content on composition maintenance system 324, content may be stored in data store 356 and accessed by composition maintenance system 324. Data store 356, as previously mentioned, may also store information relating to permissions and/or security levels. For example, data store 356 may be arranged to store a table which cross-references identifying information for a user with permissions and/or a security level associated with the user, as well as a table which cross-references tags with permissions and/or security levels associated with the tags.

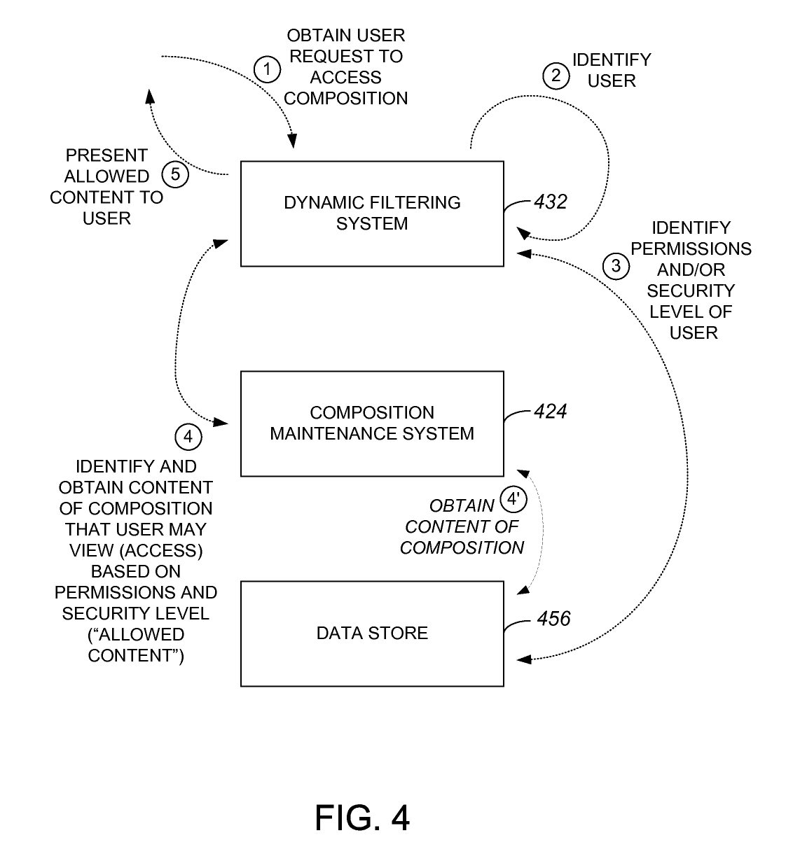

With reference to FIG. 4, a process of presenting content to a user will be described in accordance with an embodiment. An overall system includes a composition maintenance system 424, a dynamic filtering system 432, and a data store 456. In the embodiment as shown, dynamic filtering system 432 obtains a user request to access a composition. Upon obtaining the user request to access the composition, dynamic filtering system 432 identifies the user, and then cooperates with data store 456 to identify permissions and/or the security level of the user. In the described embodiment, data store 456 is arranged to maintain information which identifies the permissions and/or the security levels of various users. It should be appreciated that data store 456 may be optional, e.g., when a composition and/or information which identifies the permissions and/or security level of various users is provided substantially in real-time.

Once permissions and/or a security level of the user is identified, dynamic filtering system 432 cooperates with composition maintenance system 424 to identify and to obtain content of the composition that the user may view, i.e., allowed content. That is, dynamic filtering system 432 and composition maintenance system 424 cooperate to identify sections of content within a composition that the user has appropriate permissions and/or an appropriate security level to view. Although composition maintenance system 424 may store at least some content of the composition, composition maintenance system 424 may instead optionally obtain at least some content of the composition from data store 456. After the sections of content that the user may view or otherwise access are identified, dynamic filtering system 432 may present or portray the sections of content to the user.

In one embodiment, if the composition is obtained in real-time, e.g., if the composition is “live” and in the process of being created, then composition maintenance system 424 may effectively serve as a buffer that does not actually store the composition. That is, a composition may be obtained from a live input source. It should be appreciated that a composition which is obtained from a live input source may be substantially processed without being provided to composition maintenance system 424.

Although only a few embodiments have been described in this disclosure, it should be understood that the disclosure may be embodied in many other specific forms without departing from the spirit or the scope of the present disclosure. By way of example, a user may have associated permissions and an associated security level, or a user may have an associated security level, and permissions may be inferred from the associated security level. In one embodiment, a user with a relatively high associated security level may be assumed to have permission, or authorization, to view information on substantially any topic, whereas a user with a relatively low associated security level may be assumed to have permission to view information on only very basic topics.

Less restrictive permissions and/or higher security levels may include the capability to edit content of a composition. For example, while a user with the most restrictive permissions may not be allowed to make modifications to the contents of a composition, a user with less restrictive permissions may be allowed to make modifications to the contents of a composition. In other words, permissions and security levels may refer to editing capabilities, and are not limited to viewing capabilities. Generally, different sections of content may have different editing modes.

An interface which allows a dynamic filter to be applied may generally vary widely. In one embodiment, applying a dynamic filter with respect to viewing a composition may involve providing a user interface which facilitates the application of a dynamic filter. The user interface may enable a party, e.g., an owner of a composition, to readily apply the dynamic filter and, thus, readily select the content he or she shares. An owner of a composition may use such a user interface to effectively specify the content of the composition that is to be displayed. Such a user interface may be provided in a browser as a scroll bar that may be used to change privileges associated with the composition. For example, a scroll bar may be used such that an owner may scroll between sharing or otherwise displaying sections of content associated with a high security level and sharing or otherwise displaying sections of content associated with a low security level. A user interface may also be implemented as an input box that allows the name of a user to be entered such that a dynamic filter may then be applied based on the name of the user and, thus, the permissions and/or security level assigned to the user.

In one embodiment, the background or borders of a page, e.g., a page in a browser which displays sections of content of a composition, may be arranged to indicate a security level or a privilege level associated with the displayed sections of content. For instance, if the sections of content that are displayed on a page are associated with the lowest security level in a system, the background or borders of the page may be substantially marked to indicate that the sections of content are viewable by those with the lowest security level. The markings, e.g., highlighting, of the background or borders may be updated as the sections of content that are displayed are updated. Typically, information provided by a dynamic filter may be used to update the markings of the background or borders.

When visual aspects are incorporated in the display of aggregated content, the visual aspects may enable the permissions and/or security levels or, more generally, privileges associated with the aggregated content to be displayed. That is, indications of the privileges associated with each section of the aggregated content may be provided. Thus, an owner of the aggregated content may readily determine which sections of aggregated content are shared with users having different permissions and/or security levels.

While an instance of content or a composition that includes aggregated content has been described as being a composition such as a document, blog or a wiki, it should be appreciated that a composition may be any suitable composition or file. For example, a composition may be a video file, a presentation file, or a spreadsheet file without departing from the spirit or the scope of the disclosure. As will be appreciated by those skilled in the art, a video file may include complex and/or elementary streams of data and, thus, a video file may be an instance of complex content and/or an instance of elementary content. In general, aggregated or managed content may be included in substantially any work, instrument, or package.

Tags have been described as being associated with content to generally indicate the types of permissions and/or security levels that are needed in order to gain access to the content. It should be appreciated, however, that in lieu of using tags, other constructs may be utilized to indicate the types of permissions and/or security levels that are needed in order to gain access to content. For instance, metadata may be used to indicate permissions and/or security levels needed in order to gain access to content. Flags may also be used to indicate permissions and/or security levels needed in order to gain access to content.

In addition to, or in lieu of, providing visual indicators which indicate the permissions and/or security levels associated with content, audible indicators may be provided. Audible indicators, e.g., undertones, may be provided when content is rendered to provide an indication of sections of content that a particular security level may effectively access.

The embodiments may be implemented as hardware and/or software logic embodied in a tangible medium that, when executed, is operable to perform the various methods and processes described above. That is, the logic may be embodied as physical arrangements or components. A tangible medium may be substantially any computer-readable medium that is capable of storing logic which may be executed, e.g., by a computing system, to perform methods and functions associated with the embodiments. Such computer-readable mediums may include, but are not limited to including, physical storage or memory devices. Executable logic may include code devices, computer program code, and/or executable computer commands or instructions. In general, the devices and arrangements associated with the present disclosure may include hardware and/or software logic.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
identifying content associated with a composition, the content being a subject of a request for access, the request for access being associated with a user, wherein the content is an aggregate of a plurality of sections, the plurality of sections including at least a first section with a first authorization level and a second section with a second authorization level, the first authorization level being lower than the second authorization level;
identifying at least one authorization associated with the user;
determining if the at least one authorization indicates that the user may access at least the first section;
determining if the at least one authorization indicates that the user may access at least the second section; and
dynamically filtering the content associated with the composition, wherein dynamically filtering the content associated with the composition includes portraying the at least first section to the user if it is determined that the user may access at least the first section and portraying the at least second section to the user if it is determined that the user may access at least the second section.

2. The method of claim 1 wherein the at least one authorization associated with the user is at least one selected from the group including permissions and a security level.

3. The method of claim 1 wherein if it is determined that the at least one authorization indicates that the user may access at least the first section and wherein if it is determined that the at least one authorization indicates that the user may not access at least the second section, the at least second section is not portrayed to the user.

4. The method of claim 1 further including:
obtaining the request for access; and
identifying the user, wherein identifying the user includes identifying the user using the request for access.

5. The method of claim 1 wherein determining if the at least one authorization indicates that the user may access at least the first section includes comparing the at least one authorization with the first authorization level and wherein determining if the at least one authorization indicates that the user may access at least the second section includes comparing the at least one authorization with the second authorization level.

6. The method of claim 5 wherein if it is determined that the user may access at least the first section, the method further includes:
portraying each section of the plurality of sections with an authorization level lower the first authorization level to the user.

7. The method of claim 5 wherein if it is determined that the user may access at least the second section, the method further includes:
portraying each section of the plurality of sections with an authorization level lower the second authorization level to the user.

8. The method of claim 1 wherein portraying the at least first section to the user includes providing a first visual aspect arranged to identify the first authorization level and wherein portraying the at least second section to the user includes providing a second visual aspect arranged to identify the second authorization level.

9. A computer-readable medium comprising computer program code, the computer program code, when executed, configured to:
identify content associated with a composition, the content being a subject of a request for access, the request for access being associated with a user, wherein the content is an aggregate of a plurality of sections, the plurality of sections including at least a first section with a first authorization level and a second section with a second authorization level, the first authorization level being lower than the second authorization level;
identify at least one authorization associated with the user;
determine if the at least one authorization indicates that the user may access at least the first section;
determine if the at least one authorization indicates that the user may access at least the second section; and
dynamically filter the content associated with the composition, wherein the computer code configured to dynamically filter the content associated with the composition includes computer code configured to portray the at least first section to the user if it is determined that the user may access at least the first section and computer code configured to portray the at least second section to the user if it is determined that the user may access at least the second section.

10. The computer-readable medium comprising computer program code of claim 9 wherein the at least one authorization associated with the user is at least one selected from the group including permissions and a security level.

11. The computer-readable medium comprising computer program code of claim 9 wherein if it is determined that the at least one authorization indicates that the user may access at least the first section and wherein if it is determined that the at least one authorization indicates that the user may not access at least the second section, the at least second section is not portrayed to the user.

12. The computer-readable medium comprising computer program code of claim 9 wherein the computer program code is further configured to:
obtain the request for access; and
identify the user, wherein the computer program code configured to identify the user is configured to identify the user using the request for access.

13. The computer-readable medium comprising computer program code of claim 9 wherein the computer program code configured to determine if the at least one authorization indicates that the user may access at least the first section includes computer program code configured to compare the at least one authorization with the first authorization level and wherein the computer program code configured to determine if the at least one authorization indicates that the user may access at least the second section includes computer program code configured to compare the at least one authorization with the second authorization level.

14. The computer-readable medium comprising computer program code of claim 13 wherein if it is determined that the user may access at least the first section, the computer program code is further configured to:
portray each section of the plurality of sections with an authorization level lower the first authorization level to the user.

15. The computer-readable medium comprising computer program code of claim 13 wherein if it is determined that the user may access at least the second section, the computer program code is further configured to:
portraying each section of the plurality of sections with an authorization level lower the second authorization level to the user.

16. The computer-readable medium comprising computer program code of claim 9 wherein the computer program code configured to portray the at least first section to the user is further configured to provide a first visual aspect arranged to identify the first authorization level and wherein the computer program code configured to portray the at least second section to the user is further configured to provide a second visual aspect arranged to identify the second authorization level.

17. An apparatus comprising:
means for identifying content associated with a composition, the content being a subject of a request for access, the request for access being associated with a user, wherein the content is an aggregate of a plurality of sections, the plurality of sections including at least a first section with a first authorization level and a second section with a second authorization level, the first authorization level being lower than the second authorization level;
means for identifying at least one authorization associated with the user;
means for determining if the at least one authorization indicates that the user may access at least the first section;
means for determining if the at least one authorization indicates that the user may access at least the second section; and
means for dynamically filtering the content associated with the composition, wherein the means for dynamically filtering the content associated with the composition includes means for portraying the at least first section to the user if it is determined that the user may access at least the first section and means for portraying the at least second section to the user if it is determined that the user may access at least the second section.

18. An apparatus comprising:
a dynamic filtering system, the dynamic filtering system being arranged to obtain a request for a party to access aggregated content and to dynamically filter the request to determine whether the party is authorized to access at least one section of a plurality of sections included in the aggregated content, wherein the dynamic filtering system is further arranged to present the at least one section to the party when it is determined that the party is authorized to access the at least one section; and
a composition maintenance system, the composition maintenance system being configured to aggregate the plurality of sections of the aggregated content into a composition.

19. The apparatus of claim 18 wherein the at least one section includes a tag and the dynamic filtering system is further arranged to obtain an authorization level of the party, and wherein the authorization level is compared to the tag to determine whether the party is authorized to access the at least one section.

20. The apparatus of claim 18 wherein the dynamic filtering system is configured to obtain the request from the party.

21. The apparatus of claim 18 further including:
a data store, the data store being arranged to store the aggregated content, wherein the composition maintenance system is arranged to communicate with the data store to access the aggregated content.

22. The apparatus of claim 18 wherein the dynamic filtering system is further arranged to provide an indication of an authorization level needed to access the at least one section when the dynamic filtering system presents the at least one section to the party.

23. The apparatus of claim 18 wherein the composition is one selected from a group including a document, a blog, and a wiki.
